(19) United States
(12) Patent Application Publication
(10) Pub. No.: US 2010/0119101 A1
(43) Pub. Date: May 13, 2010

(54) Integrated Audiovisual Output Device

(76) Inventor: Roger A. Fratti, Berks County, PA (US)

Correspondence Address: RYAN, MASON & LEWIS, LLP, 90 FOREST AVENUE, LOCUST VALLEY, NY, 11560, US

(21) Appl. No.: 12/598,697

(22) PCT Filed: May 3, 2007
(86) PCT No.: PCT/US07/68096

§ 371 Date: Nov. 3, 2009

(51) Int. Cl. H04R 1/02; G09G 3/20; G09G 3/36; H04R 1/00; H04R 9/06; G06F 3/038

(52) U.S. Cl. 381/388; 345/55; 345/87; 381/400; 381/412; 345/205

(57) ABSTRACT

An integrated audiovisual output device includes at least one display comprising at least one panel, at least one voice coil contiguous with the at least one panel, and at least one magnet proximate to the at least one voice coil, wherein the at least one panel is vibrated in order to generate audio output. Another integrated audiovisual output device includes at least one display comprising at least one panel, at least one magnet contiguous with the at least one panel, and at least one voice coil proximate to the at least one magnet, wherein at least one panel is vibrated in order to generate audio output. Another integrated audiovisual output device includes at least one display comprising at least one panel and an audio transducer for vibrating at least one panel of the at least one display, wherein at least one panel comprises driver circuitry operative to produce at least audio data for presentation by the audio transducer.

### FIELD OF THE INVENTION

The present invention relates generally to an output device, and more particularly relates to an integrated audiovisual output device.

### BACKGROUND OF THE INVENTION

Electronic devices with audiovisual capabilities have grown increasingly smaller and commonplace. Accordingly, miniaturization of audiovisual components has also grown important. However, traditional designs have required separate components for presenting video (e.g., a liquid crystal display (LCD) including two panels, typically composed of glass, with a liquid crystal layer therebetween) and audio (e.g., a speaker cone attached to a voice coil).

Recent developments in technology have led to attempts to integrate these audio and video components. For example, U.S. Pat. No. 6,427,017 teaches arranging a transparent piezoelectric speaker panel over an LCD display. Such an arrangement has the disadvantage of an increased thickness of the front panel, which results in both an increase in the device size as well as a decrease in the brightness and clarity of the display. Furthermore, piezoelectric elements have a relatively narrow frequency response compared to other audio output devices (e.g., electromagnetic speakers).

U.S. Patent Application Publication No. 2006/0227981 teaches attaching a piezoelectric excitation source to an end of one of the LCD substrate, thereby permitting the substrate to be used as a vibration plate in conjunction with an externally supplied sound signal. Although an improvement over the prior art, this requires both the use of a piezoelectric excitation source and an externally supplied sound signal, which results in both increased device size (due to the external excitation source and external generation of the sound signal) and diminished frequency response (due to the use of piezoelectric rather than electromagnetic technology). Moreover, many amplifier circuits have difficulty driving piezoelectric devices, which are primarily capacitive loads.

Accordingly, there exists a need for an integrated audiovisual output device which does not suffer from one or more of the above-noted problems exhibited by conventional devices.

### SUMMARY OF THE INVENTION

The present invention meets the above-noted need by providing, in an illustrative embodiment thereof, an integrated audiovisual output device with a voice coil and/or a magnet contiguous with a display panel.

In accordance with one aspect of the invention, an integrated audiovisual output device includes at least one display comprising at least one panel, at least one voice coil contiguous with the at least one panel, and at least one magnet proximate to the at least one voice coil, wherein at least one panel is vibrated in order to generate audio output. The device may also include at least one frame arranged to house at least the at least one panel and the at least one voice coil. The at least one voice coil may, for example, be housed within the at least one frame or embedded within the at least one frame. The at least one magnet may, for example, be housed within the frame, embedded within the frame, or external to the frame.

In accordance with another aspect of the invention, an integrated audiovisual output device includes at least one display comprising at least one panel, at least one magnet contiguous with the at least one panel, and at least one voice coil proximate to the at least one magnet, wherein at least one panel is vibrated in order to generate audio output. The device may also include at least one frame arranged to house at least the at least one panel and the at least one magnet. The at least one magnet may, for example, be housed within the at least one frame or embedded within the at least one frame. The at least one voice coil may, for example, be housed within the frame, embedded within the frame, or external to the frame.

In accordance with another aspect of the invention, an integrated audiovisual output device includes at least one display comprising at least one panel and an audio transducer for vibrating at least one panel of the at least one display, wherein at least one panel comprises driver circuitry operative to produce at least audio data for presentation by the audio transducer. The at least one panel comprising driver circuitry may itself be vibrated or the display may include at least a first panel comprising driver circuitry and a second panel which is vibrated. The audio transducer may include, for example, a piezoelectric element and/or a voice coil.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 is a cross-sectional view showing at least a portion of an exemplary integrated audiovisual device having a voice coil contiguous with a display panel and a magnet external to a frame of the device, in accordance with an embodiment of the invention.

FIG. 2 is a cross-sectional view showing at least a portion of an exemplary integrated audiovisual device having a voice coil contiguous with a display panel and a magnet embedded within a frame of the device, in accordance with an embodiment of the invention.

FIG. 3 is a cross-sectional view showing at least a portion of an exemplary integrated audiovisual device having a voice coil contiguous with a display panel and a magnet housed within a frame of the device, in accordance with an embodiment of the invention.

FIG. 4 is a cross-sectional view showing at least a portion of an exemplary integrated audiovisual device having a magnet contiguous with a display panel and a voice coil external to a frame of the device, in accordance with an embodiment of the invention.

FIG. 5 is a cross-sectional view showing at least a portion of an exemplary integrated audiovisual device having a magnet contiguous with a display panel and a voice coil embedded within a frame of the device, in accordance with an embodiment of the invention.

FIG. 6 is a cross-sectional view showing at least a portion of an exemplary integrated audiovisual device having a magnet contiguous with a display panel and a voice coil housed within a frame of the device, in accordance with an embodiment of the invention.

FIG. 7 is a cross-sectional view showing at least a portion of an exemplary integrated audiovisual device wherein a display panel contains driver circuitry and is vibrated to produce audio output.

FIG. 8 is a cross-sectional view showing at least a portion of an exemplary integrated audiovisual device wherein a first display panel contains driver circuitry and a second display panel is vibrated to produce audio output.

### DETAILED DESCRIPTION OF THE INVENTION

At least one aspect of the present invention will be described herein in the context of illustrative devices including a single liquid crystal display, a single spiral induction voice coil, a single permanent magnet, and a single frame. While reference may be made herein to certain device components, it is to be understood that the present invention is not limited to these or any particular device components or arrangements thereof. Rather, the invention is more generally applicable to techniques for integrated audiovisual output. For example, this device may be used with any number and type of displays, including, but not limited to, liquid crystal displays, plasma screens, touch-sensitive screens, electronic paper displays, light-emitting diodes, thin-film transistor (TFT) displays, etc. Each display may include any number and type of panels, which may include, for example, glass, plastic, amorphous silicon, polysilicon, continuous-grain silicon, etc., or any substantially transparent material. Likewise, this device may be used with any number and type of voice coils (including, but not limited to, spiral induction coils), and magnets (including, but not limited to, permanent magnets and electromagnets). Furthermore, the device may be constructed with any number of frames or with no frame. Techniques of the present invention provide an integrated audiovisual output device having decreased size and enhanced frequency response compared to standard audiovisual presentation arrangements. Unlike conventional approaches, the present invention permits the integration of a voice coil and/or driver circuitry with the display.

FIG. 1 is a cross-sectional view showing at least a portion of an exemplary integrated audiovisual device 100, formed in accordance with an embodiment of the invention. Audiovisual device 100 includes a display 110, which may be a liquid crystal display comprising two panels 111, 113 with a liquid crystal layer 112 therebetween. Display 110 may be affixed to a frame 130, which is preferably composed of a substantially rigid material, such as plastic and/or metal, although the invention is not limited to a rigid frame. Frame 130 is preferably substantially fixed relative to display 110, which is preferably at least partially free to move in relation to the fixed frame so as to produce vibrations. There may be an interior space 120 defined by display 110 and an interior of frame 130 (e.g., a bottom and sidewalls of the frame). This space may be at least partially occupied by, for example, backlighting circuitry 160 for use in illuminating the display 110 and/or driver circuitry 170 for use in generating audio and/or video output for presentation on audiovisual device 100. Space 120 may also serve as a resonating cavity for the audio output.

Audiovisual device 100 further comprises an audio transducer including a voice coil 140 contiguous with a panel 113 of display 110 and a magnet 150 external to frame 130. The voice coil 140 and magnet 150, when used in conjunction with one another, may be used for presenting audio output. The voice coil 140 is preferably capable of producing vibrations in at least panel 113. Voice coil 140 may be attached to panel 113 using any known attachment means, such as, for example, fasteners (e.g., screws, etc.), adhesive, etc, as will become apparent to those skilled in the art. Alternatively, voice coil 140 may, for example, be printed onto panel 113 (e.g., using electrically conductive ink, etc.). Voice coil 140 may, for example, include a spiral inductor, wire segments, or alternative means for generating an electromagnetic field when a current is passed through the voice coil. Voice coil 140 may be controlled by driver circuitry 170 which may, for example, be located on a panel 113 of display 110 (e.g., system-on-glass), in space 120, or outside frame 130. Magnet 150, which may include, for example, a permanent magnet and/or an electromagnet, may be located external to frame 130, as shown, but still proximate enough to exert a magnetic influence on voice coil 140.

When an electric current corresponding to a signal generated by driver circuitry associated with the audio transducer is passed through voice coil 140, which is within the magnetic field of magnet 150, the voice coil will attempt to move in relation to the magnet (e.g., either towards or away from the magnet, depending on a direction of the current passing through the voice coil), thus inducing vibrations in at least the contiguous panel 113.

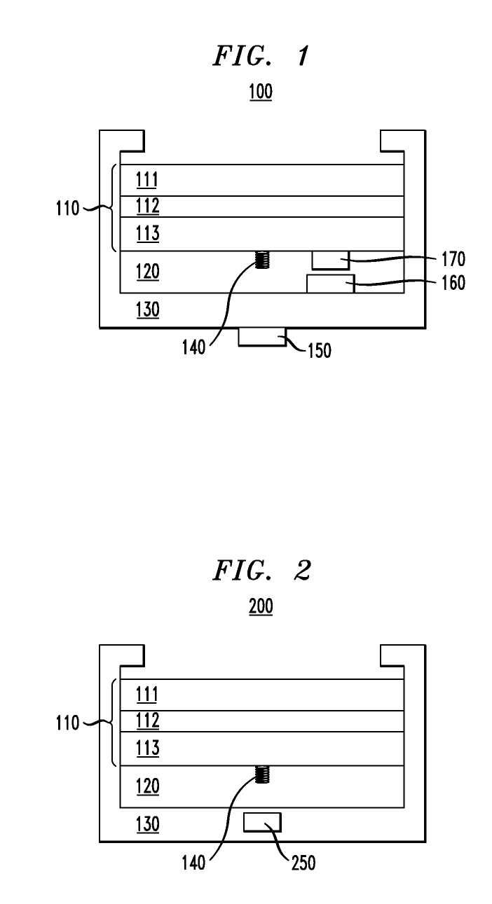

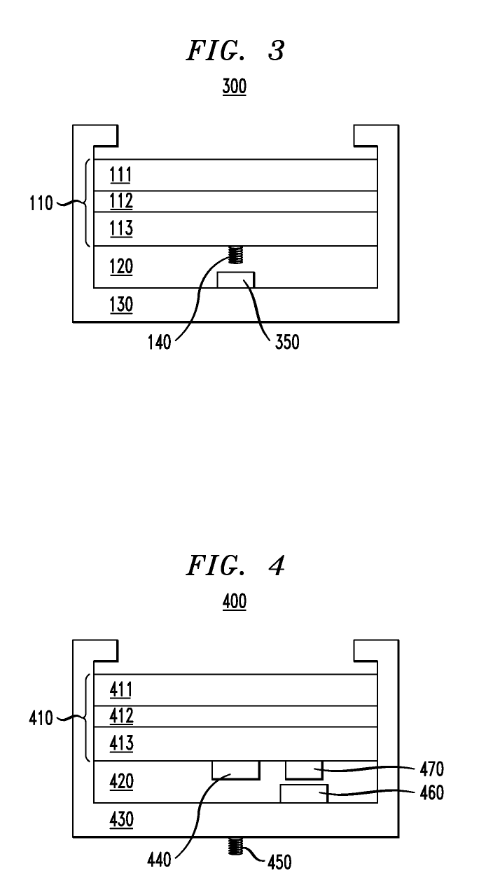

FIGS. 2 and 3 are cross-sectional views depicting alternative exemplary configurations of the integrated audiovisual device 100 shown in FIG. 1, in accordance with other embodiments of the invention. For example, FIG. 2 depicts an audiovisual device 200 including an audio transducer comprising voice coil 240 contiguous with a panel 113 of display 110, as in the audiovisual device 100 (see FIG. 1), and a magnet 250 embedded in a bottom of frame 130. It is to be understood that magnet 250 is not limited to being embedded in frame 130 in the particular location shown. Rather, magnet 250 may be embedded essentially anywhere in frame 130 that is proximate enough to voice coil 240 so as to cause the voice coil to move relative to the magnet and thereby induce vibrations at least in panel 113. For example, magnet 250 may be embedded in one or more sidewalls of frame 230. As an alternative, the frame 130 itself may comprise a magnetic material and thereby act as a magnet.

Likewise, FIG. 3 depicts an audiovisual device 300 including an audio transducer comprising voice coil 340 contiguous with panel 113 of display 110, as in the audiovisual device 100 (see FIG. 1), and a magnet 350 located housed within frame 130. Magnet 350 may, for example, be attached to frame 130 using any known attachment means, such as, but not limited to, fasteners (e.g., screws, etc.), adhesive, etc, as will become apparent to those skilled in the art. The location of magnet 350 within frame 130 is not limited to the particular location shown, but may be located essentially anywhere in frame 130 that is proximate enough to voice coil 340 so as to cause the voice coil to move relative to the magnet and thereby induce vibrations at least in panel 113. For example, magnet 350 may be attached to an interior surface of one or more sidewalls of frame 130. Alternatively, magnet 350 may, for example, be printed onto frame 130 (e.g., using magnetic ink, etc.).

FIG. 4 is a cross-sectional view showing at least a portion of an exemplary integrated audiovisual device 400, formed in accordance with another embodiment of the invention. Audiovisual device 400 includes a display 410, which may be a liquid crystal display comprising two panels 411, 413 with a liquid crystal layer 412 therebetween. Display 410 may be affixed to a frame 430, which is preferably composed of a substantially rigid material, such as plastic and/or metal, although the invention is not limited to a rigid frame. Frame 430 is preferably substantially fixed relative to display 410, which is preferably at least partially free to move in relation to the fixed frame so as to produce vibrations. There may be an interior space 420 defined by display 410 and an interior of frame 430 (e.g., a bottom and sidewalls of the frame). This space may be at least partially occupied by, for example, backlighting circuitry 460 for use in illuminating the display 410 and/or driver circuitry 470 for use in generating audio and/or video output for presentation on audiovisual device 400. Space 420 may also serve as a resonating cavity for the audio output.

Audiovisual device 400 further comprises an audio transducer including a magnet 440 contiguous with a panel 413 of display 410 and a voice coil 450 external to frame 430. The magnet 440 and voice coil 450, when used in conjunction with one another, may be used for presenting audio output. The magnet 440 is preferably capable of producing vibrations in at least panel 413. Magnet 440 may be attached to panel 413 using any known attachment means, such as, for example, fasteners (e.g., screws, etc.), adhesive, etc, as will become apparent to those skilled in the art. Alternatively, magnet 440 may, for example, be printed onto panel 413 (e.g., using magnetic ink, etc.). Magnet 440, which may include, for example, a permanent magnet and/or an electromagnet, should be located with sufficient proximity to voice coil 440 so that the magnet will be caused to move relative to voice coil 450 by a current flowing through the voice coil. Voice coil 450 may, for example, include a spiral inductor, wire segments, or alternative means for generating an electromagnetic field when a current is passed through the voice coil. Voice coil 450 may be controlled by driver circuitry (not shown) which may, for example, be located on a panel 413 of display 410 (e.g., system-on-glass), in space 420, or outside frame 430.

As in the illustrative embodiments described above, when an electric current (e.g., corresponding to a signal generated by driver circuitry) is passed through voice coil 450, which is within the magnetic field of magnet 440, the voice coil will attempt to move in relation to the magnet. However, in the exemplary audiovisual device 400, since the voice coil 450 is affixed to frame 430 and thus essentially prevented from exhibiting any significant movement, magnet 440 will attempt to move contiguous panel 413 (which is preferably free to move along frame 430) relative to the magnet, thus inducing vibrations in at least the panel. The direction of movement relative to voice coil 450 (e.g., towards or away from the voice coil) will depend upon the direction of the current passing through the voice coil.

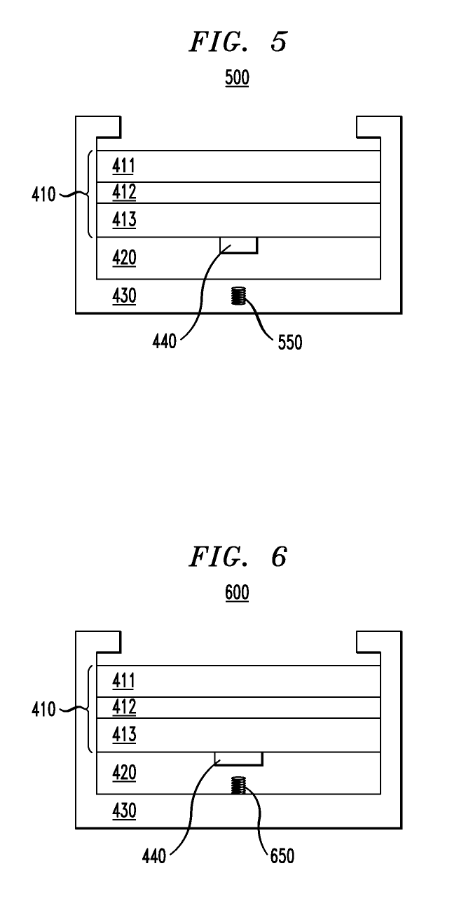

FIGS. 5 and 6 are cross-sectional views depicting alternative exemplary configurations of the integrated audiovisual device 400 shown in FIG. 4, in accordance with other embodiments of the invention. For example, FIG. 5 depicts an audiovisual device 500 including an audio transducer comprising magnet 440 contiguous with a panel 413 of display 410, as in the audiovisual device 400 (see FIG. 4), and a voice coil 550 embedded in a bottom of frame 430. It is to be understood that voice coil 550 is not limited to being embedded in frame 430 in the particular location shown. Rather, voice coil 550 may be embedded essentially anywhere in frame 430 that is proximate enough to magnet 440 so that a current passing through the voice coil is able to cause a movement of the magnet and induce vibrations at least in contiguous panel 413. For example, voice coil 550 may be embedded in one or more sidewalls of frame 430.

Likewise, FIG. 6 depicts an audiovisual device 600 including an audio transducer comprising magnet 440 contiguous with panel 413 of display 410, as in the audiovisual device 400 (see FIG. 4), and a voice coil 650 located housed within frame 430. Voice coil 650 may, for example, be attached to frame 430 using any known attachment means, such as, but not limited to, fasteners (e.g., screws, etc.), adhesive, etc, as will become apparent to those skilled in the art. The location of voice coil 650 within frame 430 is not limited to the particular location shown, but may be located essentially anywhere in frame 430 so that a current passing through the voice coil is able to cause a movement of the magnet and induce vibrations at least in panel 413. For example, voice coil 650 may be attached to an interior surface of one or more sidewalls of frame 430. Alternatively, voice coil 650 may, for example, be printed onto frame 430 (e.g., using electrically conductive ink, etc.).

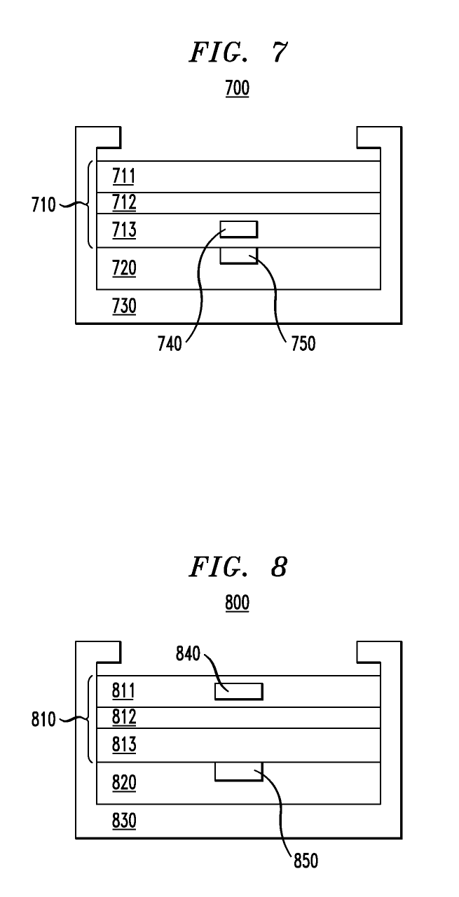

FIG. 7 is a cross-sectional view showing at least a portion of an exemplary integrated audiovisual device 700, formed in accordance with an embodiment of the invention. Audiovisual device 700 includes a display 710, which may be a liquid crystal display comprising two panels 711, 713 with a liquid crystal layer 712 therebetween. Display 710 may be mounted on a frame 730, which is preferably composed of a rigid material, such as plastic and/or metal. There may be an interior space 720 defined by display 710 and a bottom and sidewalls of frame 730, which may be at least partially occupied by, for example, backlighting circuitry for use in illuminating display 710. At least one panel 713 of display 710 is capable of being vibrated (e.g., by an audio transducer 750, which may include, for example, a piezoelectric element, a voice coil, a magnet, etc.) to produce audio output controlled at least in part by driver circuitry 740 located on the same panel (e.g., using system-on-glass methodologies). It is to be appreciated that the driver circuitry 740 and audio transducer 750 need not be located on the same panel (e.g., 713) of display 710.

For example, FIG. 8 is a cross-sectional view showing at least a portion of an exemplary integrated audiovisual device 800, formed in accordance with an embodiment of the invention. Audiovisual device 800, like device 700 depicted in FIG. 7, includes a display 810 which may be a liquid crystal display comprising first and second panels 811 and 813, respectively, with a liquid crystal layer 812 therebetween. Display 810 may be mounted to a frame 830, which is preferably composed of a substantially rigid material, such as plastic and/or metal. There may be an interior space 820 defined by display 810 and a bottom and sidewalls of frame 830, which may be at least partially occupied by, for example, backlighting circuitry for use in illuminating display 810. At least first panel 813 is preferably capable of being vibrated (e.g. by an audio transducer 850, which may include, for example, a piezoelectric element, voice coil, magnet, etc.) to produce audio output controlled at least in part by driver circuitry 840 located on at least second panel 811 (e.g., using system-on-glass methodologies).

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. An integrated audiovisual output device, comprising:
at least one display comprising at least one panel;
at least one voice coil contiguous with the at least one panel; and
at least one magnet proximate to the at least one voice coil;
wherein the at least one panel is vibrated in order to generate audio output.

2. The device of claim 1, wherein the at least one display comprises at least one liquid crystal display comprising a first panel, a second panel, and a liquid crystal layer disposed between the first panel and the second panel.

3. The device of claim 1, wherein the at least one voice coil comprises at least one spiral inductor.

4. The device of claim 1, wherein the at least one magnet comprises at least one of a permanent magnet and an electromagnet.

5. The device of claim 1, wherein the at least one panel comprises driver circuitry operative to produce audio data and/or visual data.

6. The device of claim 1, further comprising at least one frame arranged to house at least the at least one panel and the at least one voice coil;

7. The device of claim 6, wherein the at least one voice coil is embedded within the at least one frame.

8. The device of claim 6, wherein the at least one voice coil is housed within the at least one frame.

9. The device of claim 6, wherein the at least one magnet is housed within the at least one frame.

10. The device of claim 6, wherein the at least one magnet is embedded within the at least one frame.

11. The device of claim 6, wherein the at least one magnet is external to the at least one frame.

12. An integrated audiovisual output device, comprising:
at least one display comprising at least one panel;
at least one magnet contiguous with at least one panel; and
at least one voice coil proximate to the at least one magnet,
wherein at least one panel is vibrated in order to generate audio output.

13. The device of claim 12, wherein the at least one display comprises at least one liquid crystal display comprising a first panel, a second panel, and a liquid crystal layer disposed between the first panel and the second panel.

14. The device of claim 12, wherein the at least one voice coil comprises at least one spiral inductor.

15. The device of claim 12, wherein the at least one magnet comprises at least one of a permanent magnet and an electromagnet.

16. The device of claim 12, wherein at least one panel comprises driver circuitry operative to produce audio data and/or visual data.

17. The device of claim 12, further comprising at least one frame arranged to house at least the at least one panel and the at least one magnet.

18. The device of claim 17, wherein the at least one magnet is housed within the at least one frame.

19. The device of claim 17, wherein the at least one magnet is embedded within the at least one frame.

20. The device of claim 17, wherein the at least one voice coil is housed within the at least one frame.

21. The device of claim 17, wherein the at least one voice coil is embedded within the at least one frame.

22. The device of claim 17, wherein the at least one voice coil is external to the at least one frame.

23. An integrated audiovisual output device, comprising:
at least one display comprising at least one panel; and
an audio transducer for vibrating the at least one panel of the at least one display;
wherein the at least one panel comprises driver circuitry thereon operative to produce at least audio output for presentation by the audio transducer.

24. The device of claim 23, wherein the at least one display comprises at least one liquid crystal display comprising a first substrate, a second substrate, and a liquid crystal layer disposed between the first substrate and the second substrate.

25. The device of claim 23, wherein the at least one panel comprising the driver circuitry is adapted to be vibrated.

26. The device of claim 23, wherein the display comprises at least a first panel comprising driver circuitry and a second panel which is vibrated to produce audio output.

27. The device of claim 23, wherein the means for vibrating comprises at least one voice coil.

28. The device of claim 23, wherein the audio transducer comprises at least one piezoelectric element.
